(19) United States
(12) Patent Application Publication
(10) Pub. No.: US 2026/0185648 A1
(43) Pub. Date: Jul. 2, 2026

(54) DRILL-FREE MOUNTING DEVICE AND EQUIPMENT

(71) Applicant: HANGZHOU GIPUTA CLOTHING CO., LTD., Hangzhou (CN)

(72) Inventors: Yu PAN, Hangzhou (CN); Michael Alexander Mayer, Hangzhou (CN)

(73) Assignee: HANGZHOU GIPUTA CLOTHING CO., LTD., Hangzhou (CN)

(21) Appl. No.: 19/354,059

(22) Filed: Oct. 9, 2025

(30) Foreign Application Priority Data
Dec. 30, 2024 (CN) 2024232763000

(51) Int. Cl. F16M 11/04

(52) U.S. Cl. CPC F16M 11/04

(57) ABSTRACT

A drill-free mounting device and equipment, including: a supporting component is provided with a contact surface for engaging a supporting surface. A mounting base is configured to contact a product and is capable of reciprocating movement relative to the supporting component along a predetermined direction when subjected to force. A driving component is disposed between the supporting component and the mounting base and is movably connected to the supporting component. When actuated, the driving component drives the mounting base to move in a direction perpendicular to the supporting surface. The drill-free mounting device and equipment have wide applicability, easy and quick operation, safe and simple use, and low production and manufacturing cost.

### FILED OF THE INVENTION

The invention is belong to the field of mounting and fastening devices, and more particularly to drill-free mounting device and equipment.

### BACKGROUND OF THE INVENTION

Drill-free mounting has become increasingly popular due to its advantages such as preserving the integrity of exterior walls and ease of use. Examples of drill-free applications can be found in products such as clothes drying rods, storage racks, and curtain tracks. Taking curtain tracks as an example, in practical installation scenarios, a drill-free mounting device can be used to position and secure the curtain track between two supporting surfaces. However, existing drill-free mounting devices often suffer from drawbacks such as structural complexity and relatively weak structural stability.

### SUMMARY OF THE INVENTION

The present invention is directed to providing drill-free mounting device, aiming at addressing the technical problems of structural complexity and insufficient stability found in the prior art.

To achieve the foregoing objective, the present invention adopts the following technical solution:
A drill-free mounting device, comprising:
a supporting component provided with a contact surface for engaging a supporting surface;
a mounting base configured to contact a product, wherein the mounting base is capable of reciprocating movement relative to the supporting component along a predetermined direction when subjected to force;
a driving component disposed between the supporting component and the mounting base, wherein the driving component is movably connected to the supporting component;
wherein, when actuated by force, the driving component drives the mounting base to move in a direction perpendicular to the supporting surface.

Further, the driving component drives the mounting base to move relative to the supporting component toward or away from the supporting surface.

Further, the mounting base contacts the product through a base, and the base is provided with a connector for connection with the mounting base.

Further, further comprising an elastic element disposed between the base and the supporting component, wherein one end of the elastic element is connected to the supporting component and the other end is connected to the base.

Further, the end of the base adjacent to the supporting component is provided with a mounting position adapted to the elastic element.

Further, the supporting component is configured as a rectangular frame, with one end forming the contact surface and the other end forming a connection surface, and a screw rod is fixedly connected to the connection surface and extends into the interior of the rectangular frame.

Further, a connection portion disposed within the rectangular frame, configured to move along the axial direction of the screw rod when subjected to force; and
a contact portion connected to the connection portion and configured to contact the product.

Further, the driving component is provided with a threaded hole adapted to the screw rod.

Further, the contact surface engages the supporting surface through an anti-slip component.

An equipment comprising any one of the foregoing drill-free mounting devices.

The beneficial effects of the drill-free mounting device provided by the present invention are as follows:

Compared with the prior art, the drill-free mounting device of the present invention achieves adjustable length through a supporting component, a mounting base, and a driving component, thereby enabling drill-free installation. The inclusion of an anti-slip component effectively increases the static friction between the device and the supporting surfaces, thereby enhancing overall safety. The use of a base and an elastic element serves two purposes. First, the elastic element provides a preload force, facilitating the installation and fixation of the device. Second, during use, the elastic element remains in a compressed state. In the event of accidental damage to the anti-slip component, a portion of the energy stored in the elastic element is released, driving relative movement between the mounting base and the supporting component. As a result, the end surface of the supporting component can still maintain contact with the supporting surface, further improving the safety of the device during use. In summary, the device offers wide applicability, ease and speed of operation, enhanced safety, simplicity in structure, secure installation, good stability, and low production and manufacturing costs.

### BRIEF DESCRIPTION OF THE DRAWINGS

In order to more clearly illustrate the technical solutions in the embodiments of the present invention, the drawings required for describing the embodiments or the prior art are briefly introduced below. It should be understood that the drawings described below only illustrate some embodiments of the present invention. Those skilled in the art can derive other drawings based on these figures without engaging in inventive labor.

FIG. 1 is a first schematic structural diagram of a drill-free mounting device according to an embodiment of the present invention;

FIG. 2 is an exploded view of the drill-free mounting device according to an embodiment of the present invention;

FIG. 3 is a schematic structural diagram of another drill-free mounting device according to an embodiment of the present invention;

FIG. 4 is a second schematic structural diagram of the drill-free mounting device according to an embodiment of the present invention;

FIG. 5 is a third schematic structural diagram of the drill-free mounting device according to an embodiment of the present invention;

FIG. 6 is a usage schematic diagram of another drill-free mounting device according to an embodiment of the present invention, specifically illustrating the movement of the mounting base driven by a wrench tool;

FIG. 7 is a schematic structural diagram of the mounting base used in the drill-free mounting device;

FIG. 8 is a schematic structural diagram of the supporting component used in the drill-free mounting device;

FIG. 9 is a schematic structural diagram of the driving component used in the drill-free mounting device;

FIG. 10 is a schematic structural diagram of the base used in the drill-free mounting device.

### DESCRIPTION OF REFERENCE NUMERALS

1—mounting base;
11—through hole;
12—connection structure;
2—supporting component;
21—groove;
22—screw rod;
3—driving component;
31—threaded hole;
32—force-bearing portion;
4—anti-slip component;
5—base;
51—mounting position;
52—connector;
6—elastic element.

### DETAILED DESCRIPTION OF THE PREFERRED EMBODIMENTS

In order to make the technical problem to be solved, the technical solution, and the beneficial effects of the present invention more apparent, the invention is further described in detail below in conjunction with the drawings and specific embodiments. It should be understood that the specific embodiments described herein are merely intended to illustrate the invention and are not to be construed as limiting its scope.

It should be noted that the terms “first,” “second,” and the like as used in the specification and claims of the present application are intended solely to distinguish similar elements and are not meant to indicate any particular order or sequence. Such terms should be understood as interchangeable where appropriate so that embodiments of the present application may be practiced in orders other than those illustrated or described herein. Moreover, elements distinguished as “first” and “second” typically belong to the same category and are not limited in number; for example, the “first” object may refer to one or more objects. In addition, the term “and/or” as used in the specification and claims indicates that one or more of the listed elements may be included. The character “/” generally denotes an “or” relationship between the associated elements.

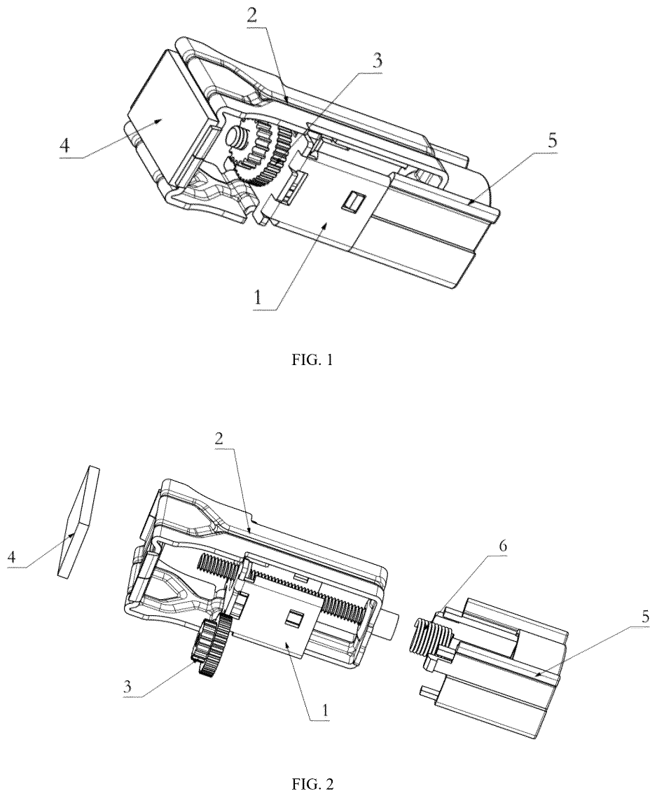

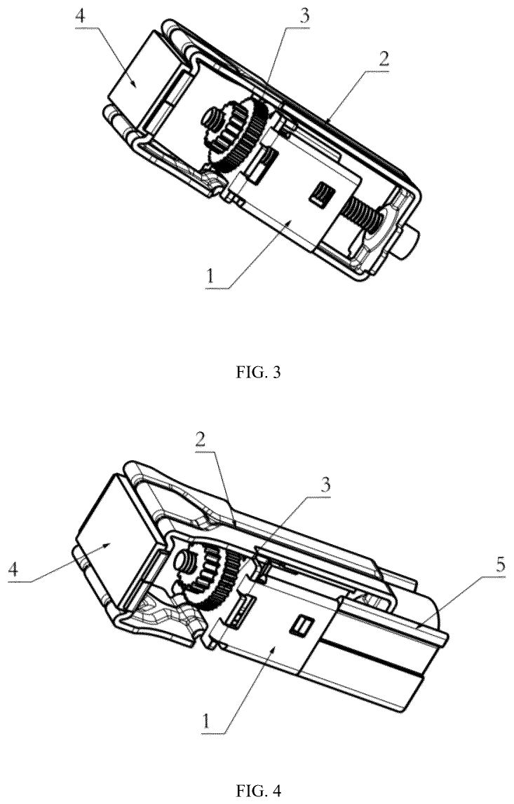

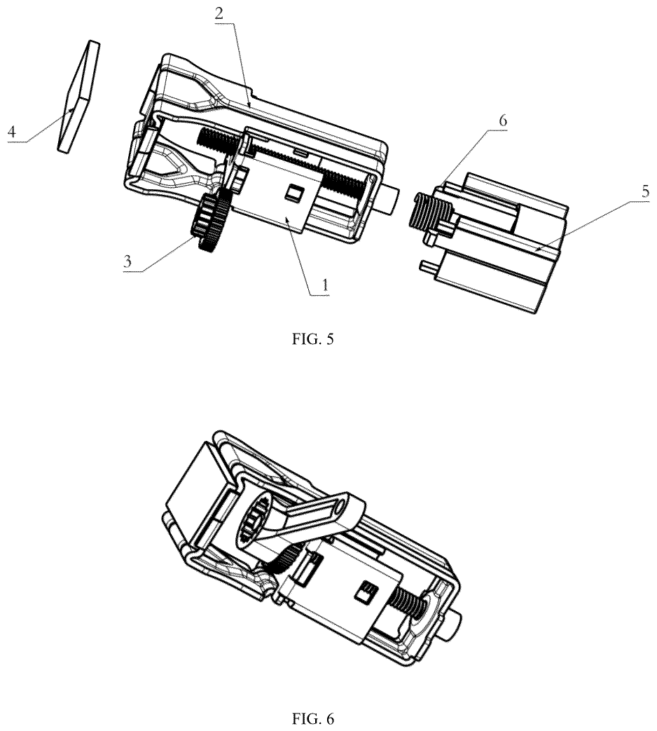

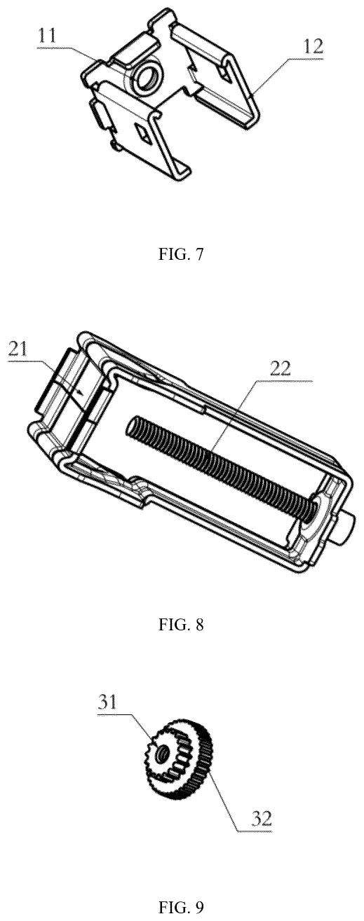

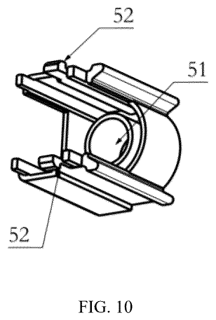

Reference is now made to FIGS. 1 through 10 for a detailed description of a drill-free mounting device provided by the present invention. The drill-free mounting device is applied to products that require fixation, wherein a force is applied between a supporting surface and the product so that the product is secured between the supporting surfaces. The device is convenient to use and does not require drilling. The drill-free mounting device comprises a supporting component 2, a mounting base 1, and a driving component 3. The supporting component 2 is provided with a contact surface for contacting the supporting surface. The mounting base 1 is configured to contact the product. When a force is applied to the mounting base 1, it reciprocates in a preset direction relative to the supporting component 2. The driving component 3 is disposed between the supporting component 2 and the mounting base 1, and is movably connected to the supporting component 2. When the driving component 3 is actuated by an external force, it drives the mounting base 1 to move in a direction perpendicular to the supporting surface. Specifically, when the driving component 3 is actuated, it drives the mounting base 1 to move relative to the supporting component 2 in a direction toward or away from the supporting surface.

In one specific embodiment of the present invention, and still referring to FIGS. 1 through 10, the supporting component 2 is configured as a rectangular frame with an opening facing forward. The mounting base 1 is located within the rectangular frame and can reciprocate relative to the supporting component 2. One end surface of the supporting component 2 serves as the contact surface, while the opposite end surface serves as the connection surface. A screw rod 22 is fixedly connected to the connection surface and extends into the interior of the rectangular frame.

In any feasible embodiment, the contact surface engages the supporting surface via the anti-slip component 4. Specifically, the front end surface of the rectangular frame serves as the contact surface, which is provided with a groove 21 configured to receive and accommodate the anti-slip component 4. The anti-slip component 4 is fixed within the groove 21, thereby securing it to the supporting component 2. The rear end surface of the rectangular frame serves as the connection surface.

In any feasible embodiment, the screw rod 22 includes a head portion and a threaded body portion connected thereto. When the screw rod 22 is fixed to the connection surface, the head portion is joined to the connection surface, and the threaded body portion extends into the rectangular frame toward the contact surface. The screw rod 22 is securely connected to the rectangular frame. Specifically, the connection may be achieved by integral molding, adhesive bonding, welding, or other fixation methods. More particularly, at least one end of the screw rod 22 is threaded and positioned within the rectangular frame, while the other end is located outside the rear end of the frame. The threaded body portion passes through the mounting base 1, allowing the mounting base 1 to reciprocate axially along the screw rod 22 relative to the supporting component 2.

In this embodiment, the anti-slip component 4 is an elastic block. During operation, the elastic block contacts the supporting surface, providing an anti-slip function. Specifically, the elastic block may be one or more structures such as a silicone pad, a rubber block, or the like. Preferably, the elastic block is a silicone pad.

As a specific embodiment of the present invention, referring to FIGS. 1 through 10, the mounting base 1 includes:
a connecting portion disposed within the rectangular frame; the connecting portion is configured to move along the axial direction of the screw rod 22 when subjected to force;
a contacting portion connected to the connecting portion; the contacting portion is configured to contact the product.

In any feasible embodiment, the connecting portion is a first plate-like structure with a through hole 11 at its middle position. The threaded body of the screw rod 22 passes through the through hole 11. The connecting portion forms a stable connection with the screw rod 22 via the through hole 11. The contacting portion is a second plate-like structure arranged perpendicular to the first plate-like structure. One end of the second plate-like structure is connected to the end face of the connecting portion, while the other end extends freely in a direction away from the groove 21. Specifically, two sets of the second plate-like structure are provided, respectively disposed at the upper and lower ends of the first plate-like structure. The second plate-like structure may be provided with a connection structure 12 for connecting with other parts, such as the base 5 described below.

As a specific embodiment of the present invention, and referring to FIGS. 1 through 10, when the driving component 3 is in operation, it provides driving force for the movement of the mounting base 1. The driving component 3 is provided with a threaded hole 31, which is threadedly engaged with the screw rod 22. Thus, the driving component 3 is capable of adjusting the relative position between the mounting base 1 and the supporting component 2. After the mounting base 1 is fixed to the corresponding product, adjusting the driving component 3 can drive the supporting component 2 to move toward the supporting surface, thereby generating a clamping force. The driving component 3 is provided with a force-bearing portion 32. The force-bearing portion 32 may be a polygonal outer ring arranged on the driving component 3, facilitating manual or tool-assisted manipulation of the driving component 3.

In some feasible embodiments, the mounting base 1 has no connection or contact with the supporting component 2, and is connected only to the driving component 3.

In some feasible embodiments, the mounting base 1 is limited by the supporting component 2. The mounting base 1 may not be connected to the driving component 3, but may merely be in contact with the driving component 3.

As a specific embodiment of the present invention, and referring to FIGS. 1 through 10, the mounting base 1 contacts the product through the base 5. The base 5 is provided with a connector 52 that is adapted to the connection structure 12. By fixedly connecting the connector 52 with the connection structure 12, the base 5 can be securely connected to the mounting base 1. Specifically, one end of the base 5 is provided with the connector 52, while the other end is configured to contact the product. The base 5 is located outside the end surface of the supporting component 2 opposite to the anti-slip component 4.

In any feasible embodiment, the connection structure 12 and the connector 52 are connected by a snap-fit. Specifically, the connection structure 12 is a U-shaped opening, and the connector 52 is a snap. The snap is engaged within the U-shaped opening, thereby connecting the connector 52 and the connection structure 12.

In another feasible embodiment, the connection structure 12 and the connector 52 are slidably connected via a slider and slide groove structure.

As a specific embodiment of the present invention, the base 5 is connected to the supporting component 2 via the elastic element 6. The elastic element 6 is disposed between the base 5 and the supporting component 2 to exert elastic force. One end of the base 5 adjacent to the supporting component 2 is provided with a mounting position 51. One end of the elastic element 6 contacts and/or limits and/or connects to the mounting position 51, while the other end contacts and/or limits and/or connects to the supporting component 2.

In any feasible embodiment, the elastic element 6 is a spring, and the mounting position 51 is a mounting hole. One end of the spring is installed in the mounting hole, and the other end abuts against the rear end surface of the supporting component 2. When the base 5 is fixedly connected to the mounting base 1, the elastic element 6 can generate elastic force to drive the rear end of the supporting component 2 and the mounting base 1 closer to each other. As a result, the supporting component 2 can exert a certain preload force relative to the supporting surface, facilitating installation. This configuration also resolves the safety risk of possible detachment during use present in existing drill-free mounting devices.

In this embodiment, the cross-sectional shape of the inner circumference of the spring corresponds to the cross-sectional shape of the head portion of the screw rod 22. That is, when the spring contacts the supporting component 2, the head portion of the screw rod 22 can be snapped into the spring. The screw rod 22 acts as a limiter for the elastic element 6, effectively improving the stability of the connection between the supporting component 2 and the elastic element 6.

### Example 1

A drill-free mounting device comprises a supporting component 2, a mounting base 1, a driving component 3, and an anti-slip component 4. The supporting component 2, mounting base 1, and driving component 3 have been described in detail above, and therefore will not be reiterated here.

During use, the product is first placed at a predetermined position, and then the device is positioned between the product and the supporting surface. The driving component 3 is then rotated to cause the mounting base 1 to move relative to the supporting component 2 until no further movement is possible. At this point, one end of the base 5 contacts the product, and the anti-slip component 4 contacts the supporting surface, thereby securing the product between the supporting surfaces.

### Example 2

A drill-free mounting device comprises a supporting component 2, a mounting base 1, a driving component 3, an anti-slip component 4, a base 5, and an elastic element 6. These components have been described in detail above and will not be repeated here.

During use, the product is first placed at a predetermined position, and then the device is positioned between the product and the supporting surface. At this time, due to the preload force provided by the elastic element 6, the specific connection position between the supporting component 2 and the mounting base 1 is adjusted, causing one end of the base 5 to contact the product and the anti-slip component 4 to contact the supporting surface, thereby initially fixing the device. The driving component 3 is then rotated to cause the mounting base 1 to move relative to the supporting component 2 and compress the elastic element 6 until it is fully compressed. At this stage, the device reaches its most stable state of use.

The drill-free mounting device provided by the present invention, compared with the prior art, achieves length adjustment through the supporting component 2, mounting base 1, and driving component 3, thereby enabling drill-free installation. The inclusion of the anti-slip component 4 effectively increases the static friction between the device and the supporting surface, enhancing safety. The use of the base 5 and elastic element 6 serves two purposes: first, to provide preload force to facilitate installation and fixation; second, during use, when the elastic element 6 is compressed, if the anti-slip component 4 is accidentally damaged, part of the energy stored in the elastic element 6 is released, driving relative movement between the mounting base 1 and the supporting component 2, so that the end surface of the supporting component 2 can still maintain contact with the supporting surface, thereby improving safety during use. In summary, the device features wide applicability, ease and speed of operation, safety, simplicity, secure installation, good stability, and low production and manufacturing costs.

The present application further provides an equipment comprising any of the drill-free mounting devices described above.

Although preferred embodiments of the present invention have been described, those skilled in the art will readily appreciate that various changes and modifications can be made to these embodiments once the basic inventive concepts are understood. Therefore, the appended claims are intended to cover preferred embodiments as well as all such modifications and variations that fall within the scope of the present invention.

Finally, it should be noted that relational terms such as “first” and “second” are used solely to distinguish one entity or operation from another, and do not necessarily require or imply any actual relationship or order between these entities or operations. Moreover, the terms “comprise,” “include,” or any variations thereof are intended to cover non-exclusive inclusions, such that a process, method, article, or apparatus that includes a series of elements includes not only those elements but also other elements not explicitly listed, or that are inherent to such process, method, article, or apparatus. Without further limitations, an element defined by the phrase “comprising a . . .” does not exclude the presence of additional identical elements in the process, method, article, or apparatus including the stated element.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

1. A drill-free mounting device, comprising:
a supporting component provided with a contact surface for engaging a supporting surface;
a mounting base configured to contact a product, wherein the mounting base is capable of reciprocating movement relative to the supporting component along a predetermined direction when subjected to force;
a driving component disposed between the supporting component and the mounting base, wherein the driving component is movably connected to the supporting component;
wherein, when actuated by force, the driving component drives the mounting base to move in a direction perpendicular to the supporting surface.

2. The drill-free mounting device according to claim 1, wherein:
the driving component drives the mounting base to move relative to the supporting component toward or away from the supporting surface.

3. The drill-free mounting device according to claim 1, wherein:
the mounting base contacts the product through a base, and the base is provided with a connector for connection with the mounting base.

4. The drill-free mounting device according to claim 3, wherein:
further comprising an elastic element disposed between the base and the supporting component, wherein one end of the elastic element is connected to the supporting component and the other end is connected to the base.

5. The drill-free mounting device according to claim 4, wherein:
the end of the base adjacent to the supporting component is provided with a mounting position adapted to the elastic element.

6. The drill-free mounting device according to claim 3, wherein:
the supporting component is configured as a rectangular frame, with one end forming the contact surface and the other end forming a connection surface, and a screw rod is fixedly connected to the connection surface and extends into the interior of the rectangular frame.

7. The drill-free mounting device according to claim 6, wherein the mounting base comprises:
a connection portion disposed within the rectangular frame, configured to move along the axial direction of the screw rod when subjected to force; and
a contact portion connected to the connection portion and configured to contact the product.

8. The drill-free mounting device according to claim 7, wherein:
the driving component is provided with a threaded hole adapted to the screw rod.

9. The drill-free mounting device according to claim 1, wherein:
the contact surface engages the supporting surface through an anti-slip component.

10. The drill-free mounting device according to claim 2, wherein:
the mounting base contacts the product through a base, and the base is provided with a connector for connection with the mounting base.

11. The drill-free mounting device according to claim 2, wherein:
the contact surface engages the supporting surface through an anti-slip component.

12. An equipment comprising the drill-free mounting device according to claim 1.
